(19) United States
(12) Patent Application Publication
(10) Pub. No.: US 2008/0136192 A1
(43) Pub. Date: Jun. 12, 2008

(54) Lid body anchor system

(75) Inventor: Tzu-Wen Sung, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/636,176

(22) Filed: Dec. 7, 2006

(51) Int. Cl. E05C 19/06; E05C 19/10; E05C 3/00

(52) U.S. Cl. 292/13; 292/24; 292/229

(57) ABSTRACT

A lid body fixing mechanism is disclosed to fix a lid body that seals an opening of a mechanical housing. The lid body has a through hole. The lid body fixing mechanism includes a blocking unit installed on an inner side of the mechanical housing and corresponding to the through hole, an operation unit installed in the through hole and pivotally connected to the lid body, and an elastic unit installed in an inner wall of the lid body. The operation unit has an operation end, a propping end, and a hook portion located on the operation end for positioning at the blocking unit. By lifting the operation unit, the hook portion is departed from the blocking unit. The elastic unit has a supporting portion protruding into the through hole and supporting the propping end, for bouncing the lifted operation unit back to an initial position.

### BACKGROUND OF THE INVENTION

1. Field of the Invention

This invention relates generally to lid body fixing mechanisms, and more specifically, to a lid body fixing mechanism that provides an easy operation of attaching and detaching a lid body.

2. Description of Related Art

Accordingly, with the fast pace of technology nowadays, the computer processing speed is getting faster and faster, and the price is also getting lower. Therefore, the application scope of the technology has been widen greatly, such as enterprise servers or personal desktop computers, take the server as an example, a server can operate independently and be a swappable computer system, the server can be integrated inside a cage and becomes a stacked serial cage server, the mechanical housing of a cage server is commonly made out metals, and usually it is huge and heavy. For an old time cage server, mostly a lid body is placed on the top of the housing of the cage server and make sure that a plurality of holes of the lid body is aiming at a plurality of corresponding holes of the cage server, and then apply a plurality of screws to secure the lid body to the cage server, because the lid body of the cage server has a great deal of volume and weight, to aim at the holes for screwing and securing is not an easy job for the assemblers, thus the f performance efficiency is not impressive; besides, the plurality of holes and the plurality of screws raises the production cost too.

For the above-mentioned reasons, a lid body fixing mechanism is proposed, without the use of screws or tools. Referring to FIG. 1A, a front cover 11 is fixed on a top portion of a mechanical housing 1, a hook unit 12 is installed on an inside wall of the mechanical housing 1, a lid body 13 is covered on the mechanical housing 1, a through hole 131 penetrates the lid body 13, and a push portion 14 for external forces to be applied on.

Referring to FIG. 1B, the lid body 13 has an elastic chip 132 corresponding to the through hole 131 and having a fixed end 132a fixed on a bottom edge of the lid body 13, a hooking end 132b for hooking with the book unit 12 of the mechanical housing 1, and a pressing portion 132c located between the fixed end 132a and the hooking end 132b of the elastic chip 132. The pressing portion 132c corresponds in position to the through hole 131 of the lid body 13, and protrudes upward. One end of the hook unit 12 is fixed to the inner wall of the mechanical housing 1, and the other end of the hook unit 12 is an arch-shaped hooking portion 121 corresponding to the hooking end 132b of the elastic chip 132.

Please refer to FIGS. 1A and 1B at the same time, to attach the lid body 13, put the lid body 13 on the top of the mechanical housing 1 and push it toward the front cover 11, then the above-mentioned hooking end 132b of the elastic chip 132 will touch the hooking portion 121 located on the inner wall of the mechanical housing 1, the continuous pushing force makes the elastic chip 132 produce elastic deformation that makes the hooking end 132b slide along the arch-shaped hooking portion 121, move downward and forward at the same time, and finally the hooking end 132b hooks up the hooking portion 121, thus the lid body 13 fixings to the mechanical housing 1.

Referring to FIGS. 1C and 11D at the same time, oppositely, to detach the lid body 13, press down on the pressing portion 132c through the through hole 131 of the lid body 13, by doing this, the downward force on the pressing portion 132b brings out the elastic deformation of the elastic chip 132, and consequently detaches the hooking end 132b from the hooking portion 121, meanwhile the user pushes the lid body 13 outwards with force applied on the push portion 14, thus the lid body 13 is detached from the mechanical housing 1.

The above-mentioned fixing mechanism does not have the disadvantages of requiring using screws and tools, however, to detach the lid body 13, one must push down on the pressing portion 132c of the elastic chip 132, and meanwhile put force outward on the push portion 14, which is very energy consuming, furthermore, the improper coordination of any extra press down force and the outward push movement may cause damage to the elastic chip 132 and the hook unit 12, and it is very inconvenient.

Hence, it is a highly urgent issue in the industry for how to provide a lid body fixing mechanism to effectively solve the drawbacks of the prior art as mentioned above.

### SUMMARY OF THE INVENTION

In views of the disadvantages of the prior art mentioned above, it is a primary objective of the present invention to provide a lid body fixing mechanism, which is labor saving and easy to operate.

It is another objective of the present invention to provide a lid body fixing mechanism, which provides an easy means of attachment/detachment.

It is a further objective of the present invention to provide a lid body fixing mechanism, which requires using no screws or tools.

To achieve the above-mentioned and other related objectives, a lid body fixing mechanism is provided according to the present invention, the lid body fixing mechanism is capable of fixing a lid body that covers the opening of a mechanical housing, and the lid body has a through hole, the lid body fixing mechanism includes: a blocking unit, which is located on an inner wall of the mechanical housing and is corresponding to the through hole; an operation unit, which is located on the through hole and can be lifted and pivotally connect to the lid body, the operation unit consists of an operation end and an opposite propping end, the operation end has a hook portion for positioning at the blocking unit, and by lifting the operation unit departs the hook portion from the blocking unit; and an elastic unit, which is fixedly located on the inside wall of the lid body and has a supporting portion that protrudes into the through hole and supports the propping end, thereby providing the restoration elasticity for the operation unit after being lifted.

In the above-mentioned fixing mechanism, the lid body has a pair of first connect portions located on two opposite sides of the through hole, and the operation unit has a pair of second connect portions located on opposite sides between the operation end and the propping end, the pair of first connect portions can be connected to the pair of second connect portions by using connection components, thus the operation unit can be lifted and pivotally connect to the lid body. The hook portion has a leading side, which faces the blocking unit, and a fixing surface, which has its back facing the blocking unit. The first connect portion may have a blocker and the second connect portion of the operation unit may have a positioning side, when the operation unit is lifted up to a preset angle, the operation unit will prop against the blocker by the positioning side, thereby limiting the lifting angle of the operation unit, in a better embodiment, to a degree smaller than 45 degrees.

In addition, the operation end of the operation unit may have a concave for the user to operate easily, and to correspond to the concave, the lid body may further have a cover plate that covers the opening area exposed by the concave and is capable of flipping elastically inwards. In a better embodiment, one end of the cover plate has an axle connection portion, and to correspond to the axle connection portion, the lid body has a pair of cover plate connection portions located on two opposite sides of the through hole, and then by making use of an axle that runs through the axle connection portion and the pair of cover plate connection portions, the cover plate can flip inwards and pivotally connect to the lid body. In a better embodiment, each end of the axle has a torsion spring that provides the cover plate with the consistent elasticity to prop against the lid body.

In the process of attaching and fixing the lid body, by means of the design of track and slot, put the lid body on the mechanical housing and push it forward to the front cover, make sure that the hook portion of the operation unit prop against the block unit located on the inner wall of the mechanical housing, with the work of the push force and the lead of the leading side of the hook portion, the fixing surface of the hook portion props against the blocking unit, meanwhile, the lid body closely props against the front cover, thus the lid body firmly fixings to the mechanical housing. Oppositely, to detach the lid body, simply press down the cover plate, the cover plate will separate from the operation unit to form a gap between both, at this moment, move the operation end of the operation unit through the gap and apply force to lift open the operation unit, by doing this, the fixing surface of the hook portion departs from the blocking unit and the propping end of the operation unit pushes downward to the elastic unit, meanwhile, the positioning sides of the second connection portions of the operation unit prop against the blockers of the first connection portions, the applied force pivot points are where the positioning sides connect to the blockers, therefore, the user can easily detach the lid body from the mechanical housing by applying force on the operation unit.

In view of the above, the lid body fixing mechanism according to the present invention, by controlling the operation unit, the hook portion can position at or depart from the blocking unit that is located on the inner side of the mechanical housing, the lid body can freely be fixinged to a mechanical housing and cover its opening, with the simple mechanical design, the present invention enhances the labor saving efficiency of attaching/detaching a mechanical housing lid body and overcomes the drawbacks in the prior art; meanwhile, that the cover plate elastically props against the operation unit provides a cover for the concave of the operation unit and further prevents any foreign particles or dust from dropping in through the concave of the operation unit, and to detach the lid body requires two steps: push down the cover plate and operate the operation unit, therefore, the requirement of two steps further prevents the lid body from being unlocked caused by touching the operation unit mistakenly.

### BRIEF DESCRIPTION OF DRAWINGS

The present invention can be more fully understood by reading the following detailed description of the preferred embodiments, with reference made to the accompanying drawings, wherein:

FIG. 1A is a pictorial drawing, which illustrates a lid body fixing mechanism according to the prior art;

FIGS. 1B to 1D are sectional pictorial drawings, which illustrate the states of attaching/detaching of a lid body according to the prior art;

FIG. 2A is an explosive view of a lid body fixing mechanism according to the present invention;

FIG. 2B is a cross sectional view of the lid body fixing mechanism shown in FIG. 2A;

FIGS. 2C to 2E are cross sectional views illustrating attaching the lid body fixing mechanism shown in FIG. 2A to a lid body; and

FIG. 3 is a cross section view illustrating detaching the lid body fixing mechanism from the lid body.

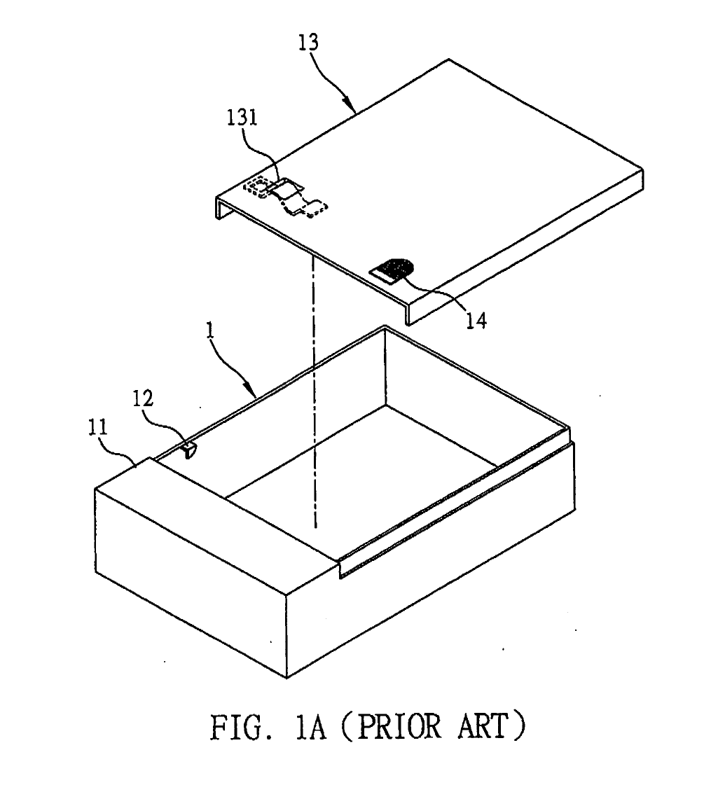

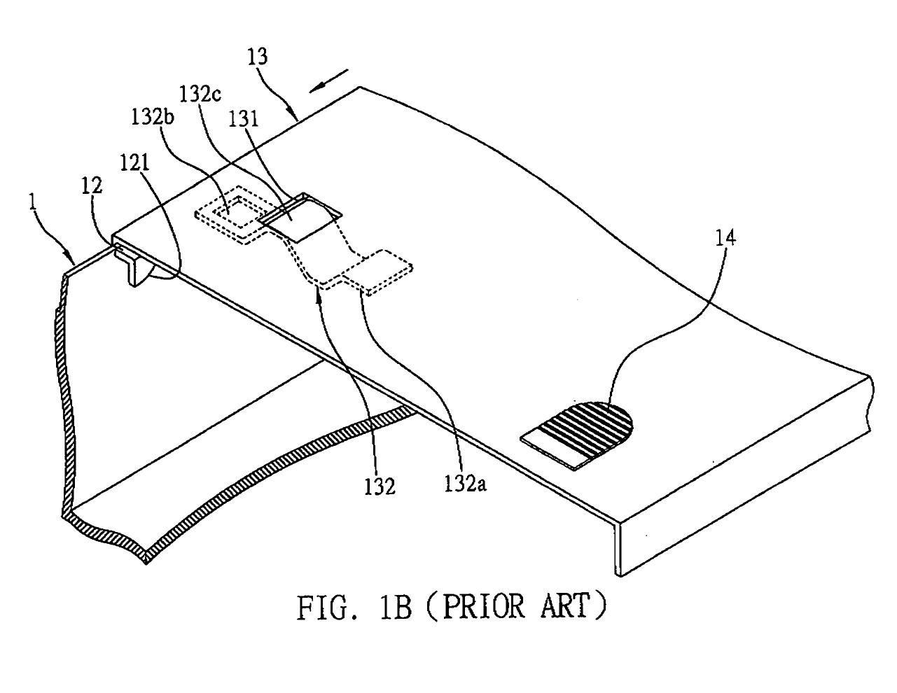

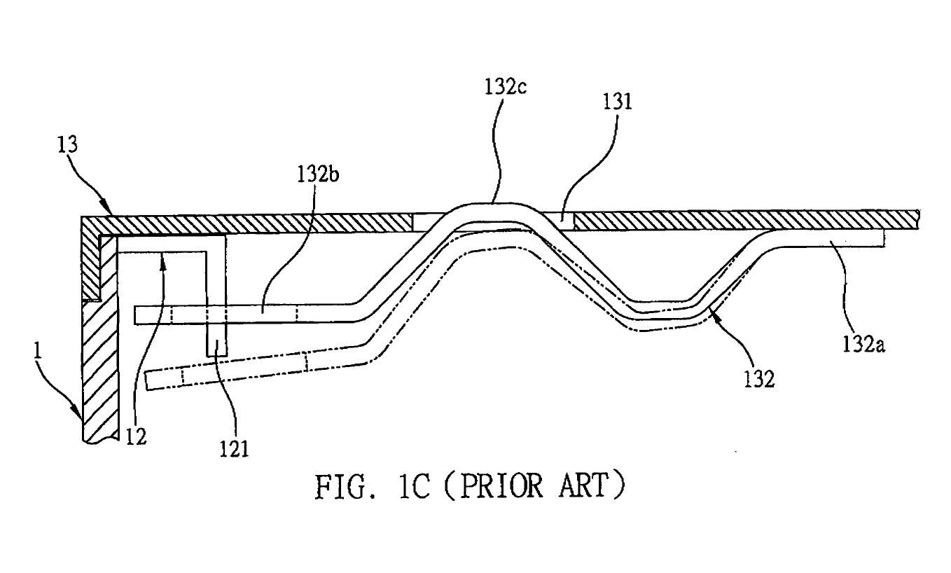

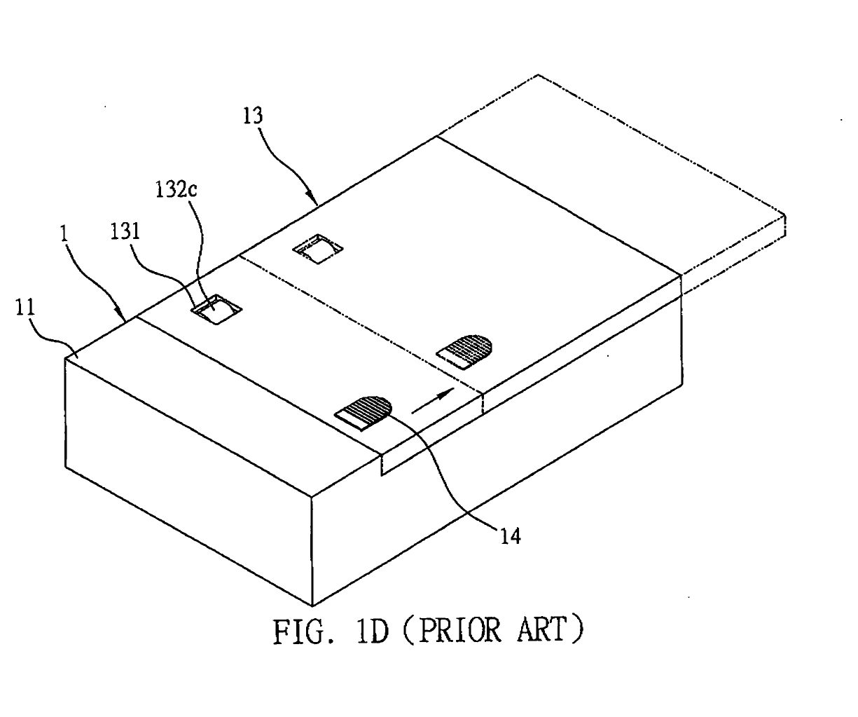

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments.

The details of the specification may be on the basis of different points and applications, and numerous modifications and variations can be devised without departing from the spirit of the present invention.

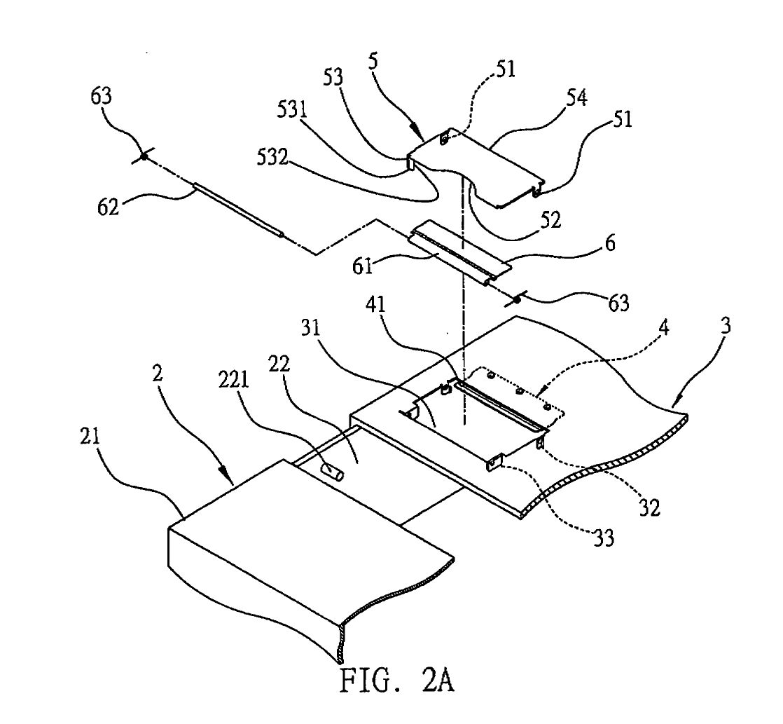

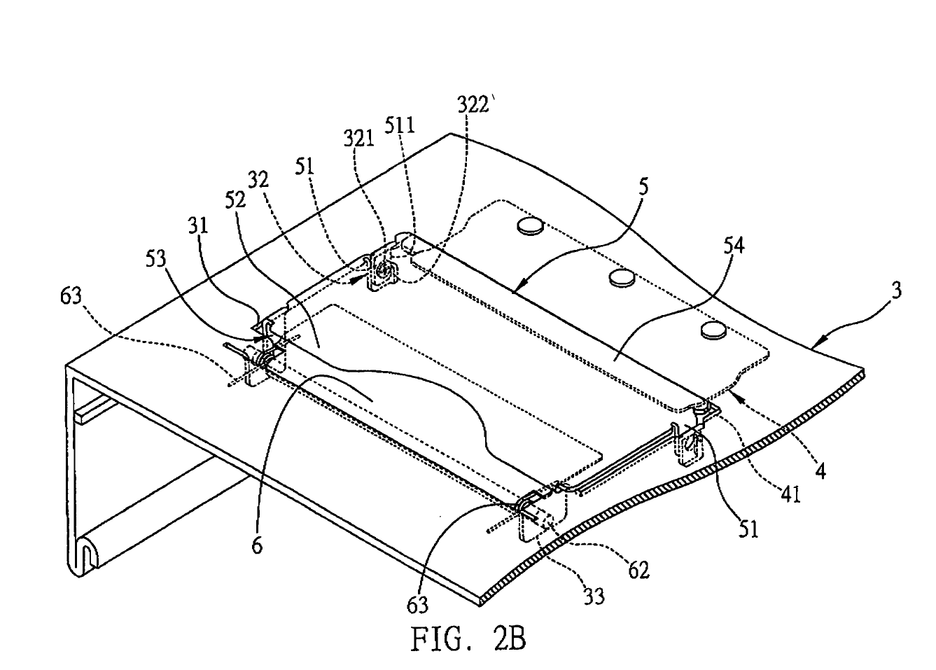

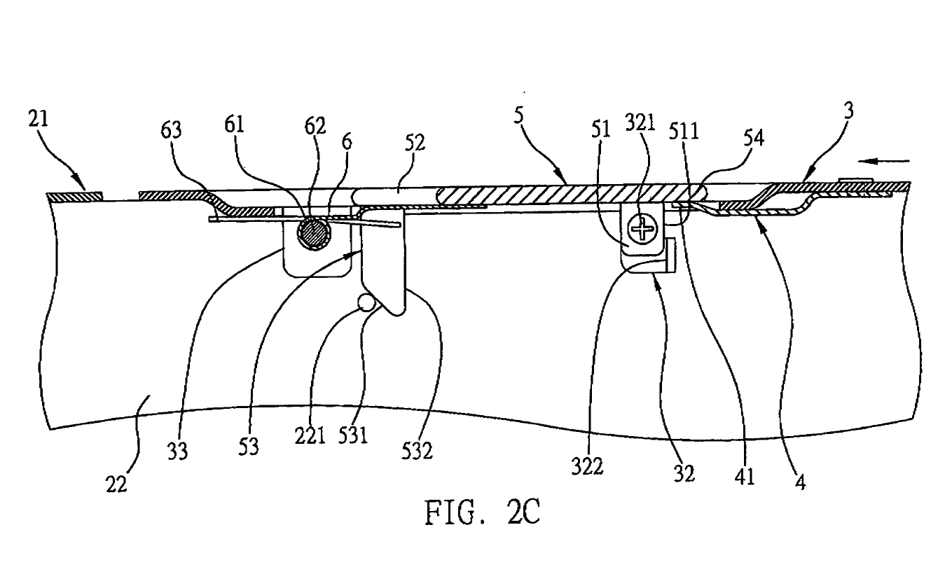

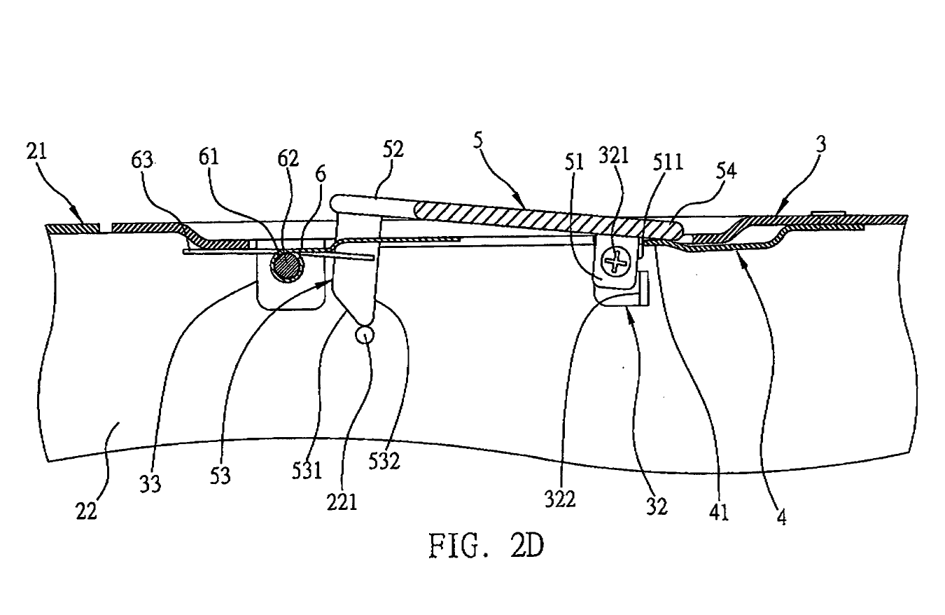

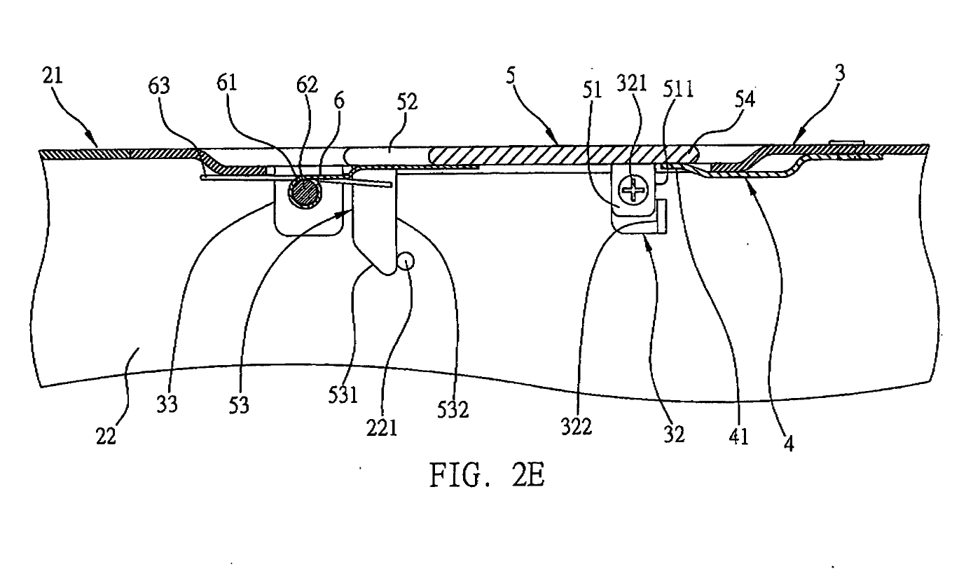

Referring to FIG. 2A, which is an explosive view of a lid body fixing mechanism according to the present invention, a front cover 21 is fixed to a mechanical housing 2 and has location and size corresponding to those of a lid body 3. After fixed to the mechanical housing 2, the lid body 3 props against the front cover 21, to seal the mechanical housing 2 completely. A blocking unit 221 such as a pillar is installed on an inner wall 22 of the mechanical housing 2. A through hole 31 is installed in the lid body 3. Two first connection portions 32 and two cover plate connection portions are installed on two inner walls of the through hole 31, the two inner walls perpendicular to the blocking unit 221.

The lid body fixing mechanism of the present invention comprises the blocking unit 221, an operation unit 5, and an elastic unit 4. The operation unit 5 is installed in the through hole 31 and pivotally connected to the lid body 3. The operation unit 5 comprises an operation end 52, an propping end 54 opposing to the operation end 52, and a hook portion 53 located on the operation end 52 for positioning on the blocking unit 221. By lifting the operation unit 5, the hook portion 53 can be departed from the blocking unit 221. The elastic unit 4 is located on the inside wall of the lid body 3 and has a supporting portion 41 that protrudes into the through hole 31 and supports the propping end 54, for bouncing the operation unit 5, after lifted, back to an initial position.

One end of the elastic unit 4 is fixed to the inner wall of the lid body 3 by means of welding, riveted joint, and bolt lock, etc., and the other end of the elastic unit 4 is the supporting portion 41, which protrudes toward the blocking unit 221 and stops at a position where the through hole 31 is installed.

Two second connection portions 51 are installed on two opposing sides of the operation unit 5, for engaging with the first connection portions 32. Each of the second connection portions 51 has a through hole. One end of the operation unit 5 is the operation end 52 that protrudes downward to form the hook portion 53. The hook portion 53 comprises a curved leading side 531 facing the blocking unit 221, and an fixing surface 532 back to the blocking unit 221. The other end of the operation unit 5 is the propping end 54. The lid body fixing mechanism further comprises a cover plate 6, one end of which is an axle connection portion 61 allowing an axle 62 to pass and further pivotally connected to the cover plate connection portion 33 located on the through hole 31. Two torsion springs 63 are mounted on both ends of the axle connection portion 61.

Referring to FIG. 2B, which is a sectional pictorial drawing illustrating the assembly locations of all the above-mentioned elements. The first connection portion 32 of the through hole 31 has through holes and a blocker 322 protruding towards the through holes. A bolt 321 is used to pivotally connect the first connection portion 32 to the second connection portion 51 of the operation unit 5. Thus, the operation unit 5 is pivotably flip in the through hole 31. The second connection portion 51 has a positioning side 511 facing the blocker 322 but back to the blocking unit 221. The propping end 54 of the operation unit 5 props against and is supported by the supporting portion 41 of the elastic unit 4. The cover plate 6 is pivotally located on the cover plate connection portion 33 of the through hole 31. Each of the torsion springs 63, which are mounted on the two ends of the axle connection portion 61, has one end propping against the bottom surface of the cover plate 6, and the other end propping against the inner surface of the lid body 3, enabling the cover plate 31 keep pressing the operation unit 5.

Referring to FIG. 2C to 2E, which are cross sectional views illustrating attaching the lid body fixing mechanism to the lid body 3. First, the lid body 3 is pushed toward the front cover 21 until the leading side 531 of the hook portion 53 reaches the blocking unit 221 located on the inner side of the mechanical housing 22. With the pushing force acting continuously, the leading side 531 leads the hook portion 53 to glide upwards, consequently, leads the propping end 54 of the operation unit 5 to elastically press down the supporting portion 41 of the elastic unit 4, at the time the movement of pushing the lid body reaches the point that the fixing surface 532 of the hook portion 53 hooks and stops at the blocking unit 221, the propping end 54 of the operation unit 5 receives the bouncing force of the supporting portion 41, and bounces back to the initial position, at this moment, the lid body 3 also reaches and connects to the front cover 21, thus, the process of fixing the lid body 3 is completed.

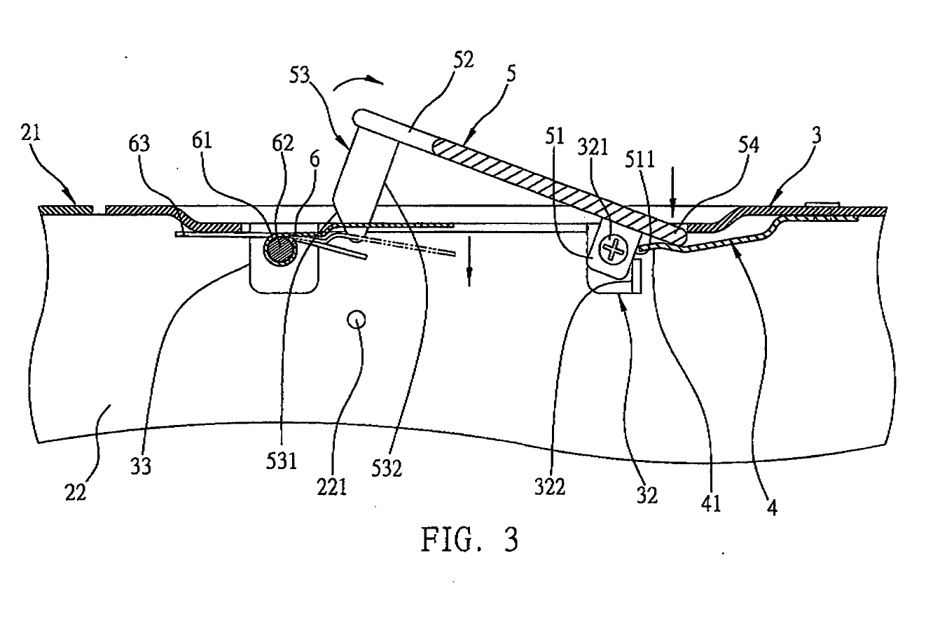

Please refer to FIG. 3, oppositely, to detach a lid body, simply press down the cover plate 6, the cover plate 6 will separate from the operation unit 5 to form a gap between both, at this moment, lift the operation end 52 of operation unit 5 through the gap and apply force to flip open the operation unit 5, by doing this, the fixing surface 532 of the hook portion 53 departs from the blocking unit 221 and the propping end 54 of the operation unit 5 pushes downward against the supporting portion 41 of the elastic unit 4, besides, the positioning side 511 of the second connection portion 51 of the operation unit 5 will prop against the blocker 322 of the first connection portion 32, because the applied force pivot point is where the positioning side 511 connects to the blocker 322, user can easily detach the lid body 3 from the mechanical housing 2 by applying force on the operation end 52.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A lid body fixing mechanism, for fixture of a lid body that seals an opening of a mechanical housing, the lid body having a through hole, the lid body fixing mechanism comprising:
a blocking unit installed on an inner wall of the mechanical housing and corresponding to the through hole;
an operation unit installed in the through hole and pivotally connected to the lid body, the operation unit comprising an operation end, a propping end opposing to the operation end, and a hook portion for being positioned on the blocking unit and departed from the blocking unit by lifting the operation unit; and
an elastic unit installed on an inner wall of the lid body and having a supporting portion protruding into the through hole and supporting the propping end, for bouncing the lifted operation unit back to an initial position.

2. The lid body fixing mechanism of claim 1, wherein the lid body has a pair of first connection portions that are located on two opposite sides of the through hole, and the operation unit has a pair of second connection portions that are located on two opposite sides between the operation end and the propping end, and, by using of a connection component to connect the first connection portions and the second connection portions, the operation unit can be lifted and pivotally connect to the lid body.

3. The lid body fixing mechanism of claim 2, wherein the first connection portion has a blocker, and the second connection portion of the operation unit has a positioning side propping against the blocker when the operation unit is lifted up to a preset angle, thereby limiting a lifting angle of the operation unit to a certain degree.

4. The lid body fixing mechanism of claim 3, wherein the lifting angle of the operation unit is smaller than 45 degrees.

5. The lid body fixing mechanism of claim 1, wherein the hook portion further comprises a leading side facing the blocking unit, and a fixing surface back to the blocking unit.

6. The lid body fixing mechanism of claim 1, wherein the operation end of the operation unit has a concave for convenient operation, and the lid body further comprises a cover plate that covers the opening of the concave and elastically flips inwards.

7. The lid body fixing mechanism of claim 6, wherein, the cover plate has an axle connection portion located on one end of the cover plate, and the lid body further comprises a pair of cover plate connection portions, which are located on two opposite sides of the through hole corresponding to the axle connection portion, by using an axle that runs through the axle connection portion and the pair of cover plate connection portions, the cover plate can flip inwards and pivotally connect to the lid body.

8. The lid body fixing mechanism of claim 7, wherein the axle is mounted with a torsion spring that provide the cover plate with the consistent elasticity to prop against the lid body.

9. The lid body fixing mechanism of claim 1, wherein the blocking unit is either of a pillar-shaped chip and a raised body.
